(19) United States
(12) Patent Application Publication
(10) Pub. No.: US 2003/0190020 A1
(43) Pub. Date: Oct. 9, 2003

(54) Automated recording of telephone numbers during ongoing telecommunication sessions

(76) Inventor: Michelle Rene Kitchings, Plano, TX (US)

Correspondence Address: GARDERE WYNNE SEWELL LLP, Suite 3000, 1601 Elm Street, Dallas, TX, 75201, US

(21) Appl. No.: 10/409,947

(22) Filed: Apr. 9, 2003

Related U.S. Application Data
(63) Continuation of application No. 09/611,678, filed on Jul. 7, 2000.

(51) Int. Cl. H04M 1/64

(52) U.S. Cl. 379/88.01; 379/88.03

(57) ABSTRACT

The present invention enables terminals to record number and/or name information during an ongoing voice communication over telecommunication systems. One aspect of the present invention allows the spoken language by the user or third party to be interpreted and converted into phone number information. Another aspect of the invention enables a terminal to record dialed number information, based on DTMF tones, which is converted into standard number data (numerals) for storage in terminal memory (e.g., speed dialing registers). Yet another aspect of the present invention allows the user to attach a voice tags or text for identifying the party associated with a recorded/stored telephone number.

### FIELD OF THE INVENTION

The present invention is generally related to the field of telecommunications and, more particularly, to electronic storage of telephone numbers and/or related information on telecommunications terminals during an ongoing telecommunication session.

### BACKGROUND

Most telecommunication terminals (e.g., wireless and fixed terminals) provide some means for the electronic storage of telephone numbers and associated party information (e.g, name or company). The stored telephone number and party information is generally searchable and can facilitate speed dialing of an identified party. The problem, however, with available methods for storage of telephone numbers and associated identifying information is that the terminal is typically in use when information regarding a number and name is being provided to the user. The user wanting to record a telephone number and name provided by a party that the user is in communication with must typically find a pen and paper to mark down the information—a problem that is further complicated if a user is operating a motor vehicle or does not have a free hand. Even phone logs that are currently available on most terminals are not helpful if, for example, the name and number being provided differs from what is recorded on a terminal's receive or transmit logs.

Terminals that can record spoken words are currently available. Although terminals are currently in existence that provide for the recordation of spoken words during an ongoing conversation, the prior art does not provide for the conversion of spoken words into numbers (e.g., “ten” into “10”). A user will eventually be required to listen to the recording and then manually record any telephone and party information into terminal memory in the usual manner (e.g., manually entering digits and numbers into a terminal memory location). Furthermore, regardless of a terminal's recording and speed dialing capabilities, the user is usually faced with essentially the same burden of recording information manually using a pen or pencil, and then later entering the information into the terminal.

What is apparently needed are improved means and systems that allow a user to record telephone number and party information into a telecommunication terminal.

### SUMMARY OF THE INVENTION

The present invention is an improvement over prior systems and methods for telephone number and/or party recordation within telecommunication terminal memories. With aspects of the present invention, a user does not have to immediately type or write down data when provided with information. Aspects of the present invention enable terminals to record number and/or name information during an ongoing voice communication over telecommunication systems.

One aspect of the present invention allows the spoken language by the user or third party to be interpreted and converted into phone number information. Another aspect of the invention enables a terminal to record dialed number information, based on DTMF tones, which is converted into standard number data (numerals) for storage in terminal memory (e.g., speed dialing registers, a number queue). Yet another aspect of the present invention allows the user to attach a voice tag for identifying the party associated with a recorded/stored telephone number.

One of the preferred embodiments of the invention provides for a terminal having a record function actuator for enabling a terminal user to invoke functions of a recognition and interpretation module during an ongoing communication; a recognition and interpretation module for recognizing audio signals and converting audio signal into telephone numbers for storage in the terminal's memory; and memory for storing telephone numbers provided by the recognition and interpretation module.

Another preferred embodiment of the invention provides a method where a user invokes recording and interpretation functions at the terminal (e.g., by a push of a button or selection of a menu item); the terminal interprets an audio signal provided by a third party in communication with the user's terminal; the terminal converts the audio signal into numbers capable of use in initiating a telecommunication session by dialing methods; and the numbers are recorded in memory.

### BRIEF DESCRIPTION OF THE DRAWINGS

FIG. 1 is a illustration of components of the invention;

FIG. 2 is a illustration of a flow chart representing method steps of the invention wherein third party (represented as a “Friend”) is in communication with a User of a Telephone;

FIG. 3 is an illustration of a state diagram showing some steps that enable a user to store data within a terminal;

FIG. 4 illustrates a state diagram wherein a terminal having searchable text and/or number directory capabilities; and

FIG. 5 is an illustration of the flow diagram for a method executed on a phone with number directory capabilities.

### DETAILED DESCRIPTION OF PREFERRED EMBODIMENTS

The general concept of the present invention is to use recording methods and mechanisms to store telephone number and/or associated party information in a phone during an ongoing conversation. The invention enables a telecommunication terminal (e.g., wired and wireless telephones) to interpret spoken numbers or DTMF tones for the purpose of recording a telephone number in the terminal's memory for future recall and use (e.g., speed dialing and reference).

Methods of the invention, as implemented on a terminal, will accept spoken words or DTMF tones and interpret the spoken words or tones and convert the words or tones into a stream of numbers representing a dialable telephone number. The invention will store the stream of numbers for future recall and use. The invention can attach party identifying information associated with the stream of numbers. The identifying information may also be obtained via speech to text technology or as a voice tag. A typical speed dialing terminal or mobile phone will have several memory locations for storage of telephone numbers as well as names in some cases.

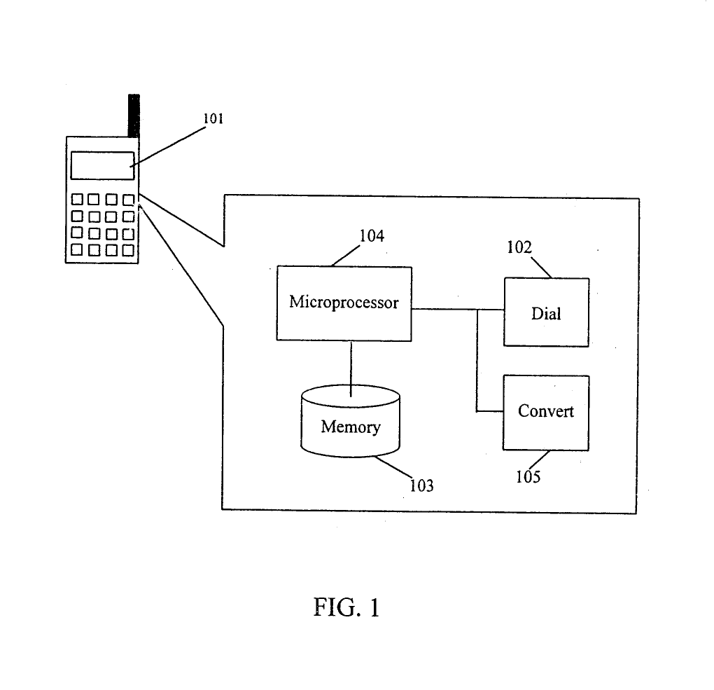

Referring to FIG. 1, a terminal 101 capable of implementing the key aspects of the present invention will include speed dialing capabilities 102, memory 103 and a microprocessor 104 programable with the inventive methods taught herein. Furthermore, the microprocessor 104 in cooperation with a medium converter 105 (e.g., speech to text, DTMF to text) will convert the spoken or dialed sounds associated with speech and DTMF tones and convert the sound or tones into numerals. The numeral would then be directed to a memory location 103. Voice recognition technology, speed dialing technology, text to speech conversion algorithms, DTMF tone interpretation technology, and sound recording are technologies that are each generally known in the telecommunication art. Each technology, however, are combined to provide separate features of the system and methods of the present invention.

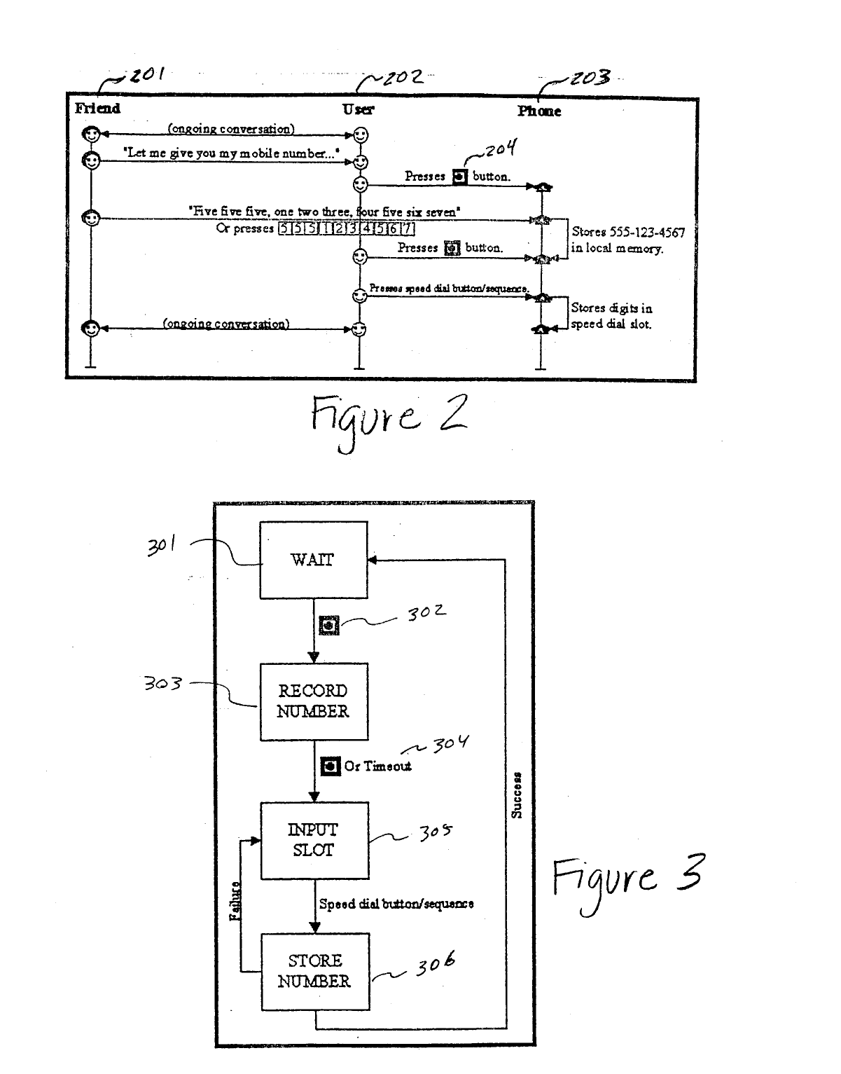

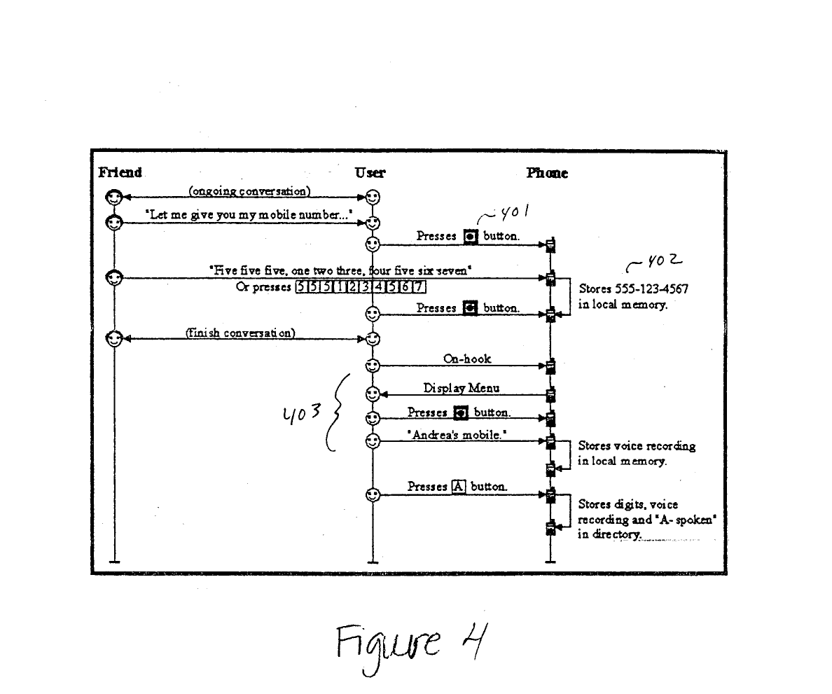

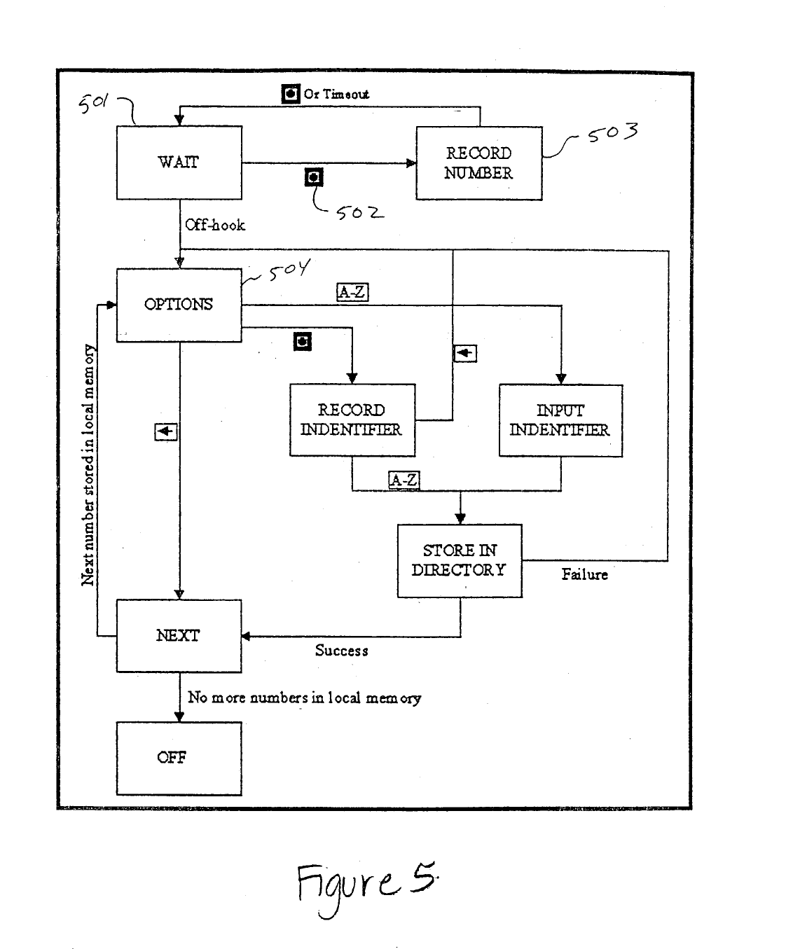

Referring to the example in FIG. 2, a flow chart is illustrated representing method steps for a Friend 201, User 202 and Telephone 203. The User 202 is shown engaged in an ongoing conversation with Friend 201. Friend 201 wants to give User 202 her telephone number. Friend says, “let me give you my mobile number.” User presses a record button 204 which invokes a recording mechanism before Friend says, for example, the number “five five five, one two three, four five six seven”). The phone records the spoken numbers and converts them into the numerals “555-123-4567”. The system then stores the digits in memory. Memory storage methods for speed dial and directory functions are known in the art with respect to telecommunication terminals. Storage may occur when the User 202 presses the record button 204 once again to stop the system from recording. Alternatively, the user may select a speed dial button or number for storage of the telephone number. Speed dial numbers are typically available on wire-line terminals. Once the number is stored, the User 202 may select a speed dial number when dialing Friend 201. The method is more flexible in that it allows a user to continue communication without having to look for a writing instrument and piece of paper to record a telephone number during an ongoing conversation.

The method described in FIG. 2 is typical of a terminal having basic speed dialing capabilities where a terminal button is assigned to a stored number. On such a terminal recorded name would not be necessary.

Referring to FIG. 3, a state diagram is illustrated that shows a users ability to enter data multiple times. The number recording functionality can be sitting in wait 301 on the terminal during an ongoing conversation until it is invoked by the user. When the user presses a record button 302, the telephone will begin recording and interpreting 303 the spoken words or DTMF tones. The record function can be turned off by the user 302 (pressing the record button) or the terminal may be programmed 304 to turn off automatically (e.g., time out after maybe after 30 seconds of not getting anything recognizable). After a number stream is recorded 305, the user can assign it to a memory location 306, or the terminal may automatically assign a location. The user may assign a location to the number by, for example, selecting a keypad number after the number has been recorded (e.g, user presses *6 and the phone number that was just interpreted gets stored in speed dial location #6). The number may also be assigned by the user after the conversation is completed, at which time the user may enter identifying information (e.g., text) for the stored number (e.g., for terminal having a searchable database). After the telephone has stored a telephone number, the system can go back into “wait” until it is asked to record and convert another number.

In more sophisticated terminals, such a mobile phones, a user may have access to a display for illustrating menus and scrolling data. More sophisticated terminal may enable the user to type in identifying information for the stored number. Referring to FIG. 4, a state diagram is shown for the more sophisticated terminal having a searchable text and/or number directory, which may be representative of the typical mobile phone. The user can record a party's telephone number by, for example, depressing a record button 401 before the party starts saying the number. The phone interprets the digits and may store them in a temporary memory location. In situations where a third party has a strong accent, which prevent the system from recognizing the spoken digits, the user may ask the third party to dial his number by pressing keypad numbers on the third party's terminal. DTMF tones would then be recorded and interpreted by the system instead of speech.

Users generally dislike pressing numerous digits and working through several menus to retrieve somebody's name from the terminal. A user may instead select a number he has just recorded (and converted) with the system and use another record function 403 to record a voice tag for the number. For example the user may select a voice tag record function and say something like “Andrea's mobile” and then release record function. The number and voice tag can then be stored in a directory that is responsive to voice tags. Using speech to text technology, a terminal may also spell “Andrea's mobile.” Or alternatively, a user may temporarily identify newly stored numbers with a sequence, such as saying “spoken one,” “spoken two,” “spoken three,” after each number is recorded from a third party. The user can then rename the spoken voice tags with another voice tag (e.g, “Andrea's mobile”) or typed in text. Such a function would work well for users in a car and that would typically have to look at typed entries. The user, instead can speak into the terminal (e.g, “Andrea's mobile”) and retrieve the number to be dialed. The user may also assign the voice tag to a Letter, for example “A”, in the terminal's organized database, and the user may thereafter review and retrieve voice tags under their respective letter assignment.

Referring to FIG. 5, illustrated is another the flow diagram for a method executed on a mobile phone. The user may be required to receive multiple numbers during a single communication session (e.g, while reviewing voice mail). The system starts off in wait mode 501. The user presses the record button 502 and the phone records the number by interpreting speech or DTMF tones. After the number is recorded, the user can release the record function, at which time the number data is stored in a memory location and the system returned to a its wait mode 501. During the same session, the user may need to record another number and presses record 502 again. The system records and interprets another number and stores it separately from the first number. The system will not tie entries from a single session together. Each number/entry will be provided with separate memory locations, even if the memory locations are temporary.

Advanced speech to text software may enable a user to spell out an identifier (e.g., A-N-D-R-E-A) and add a preprogrammed voice or text tag to the identifier such as “at mobile.” “At mobile” can be set up by the user on the terminal. Other examples of add on tags are “at home,” “at office” and “at work.”

1. A telecommunication terminal adapted for the electronic storage of telephone number data during an ongoing telecommunication session, comprising:
record function actuator for enabling a terminal user to invoke functions of a recognition and interpretation module during an ongoing communication;
a recognition and interpretation module for recognizing audio signals and converting audio signal into telephone numbers for storage in the terminal's memory;
memory for storage telephone numbers provided by the recognition and interpretation module.

2. The invention of claim 1 wherein the audio signals are spoken words that are converted into telephone numbers by speech to text conversion methods in the recognition and interpretation module.

3. The invention of claim 1 wherein the audio signals are DTMF tones that are converted into telephone numbers.

4. The terminal of claim 1 wherein said memory are speed dialing locations.

5. An electronic method of recording telephone number data within a terminal during an ongoing telecommunication session, comprising:
invoking recording and interpretation functions at the terminal by the terminal user;
interpreting a audio signal provided by a third party in communication with the user's terminal;
converting the audio signal into numbers capable of use in initiating a telecommunication session by dialing methods; and
recording the numbers in memory.

6. The method of claim 5, wherein the audio signal provide by the third party is spoken language that is converted into number using speech to text conversion methods.

7. The method of claim 5, wherein the audio signal provided by the third party is DTMF tones.

8. The method of claim 5, further comprising:
recording a voice tag associated with the numbers for the purpose of identifying the numbers and enabling retrieval of the numbers for subsequent use in initiating a telecommunication session.

9. The method of claim 5, further comprising:
recording textual identifier for the numbers; and
assigning the numbers and associated textual identifier to a memory location.

10. A method of recognizing spoken or DTMF numbers within a telecommunication terminal, comprising:
accept spoken words or DTMF tones originating from a third party into a the terminal;
recognizing the spoken words or DTMF tones as a telephone number;
convert the spoken words or DTMF tones into a stream of numbers representing a dialable telephone number; and
storing the stream of numbers in terminal memory for future recall and use for dialing the number provided by the party.

11. The invention of claim 10, further comprising:
attaching party identifying information associated with the stream of numbers to the stream of numbers stored in terminal memory.

12. The invention of claim 11 wherein the identifying information is also obtained from the third party via speech to text technology.

13. The invention of claim 11 wherein the identifying information is also obtained from the third party as a voice tag.

14. The invention of claim 11 wherein the identifying information is provided by a user of the terminal in the form of a voice tag.

15. The invention of claim 11 wherein the identifying information is provided by the user of the terminal in the form of text.

16. The invention of claim 11 wherein the identifying information is provided by a user of the terminal as speech and is converted into text.

17. The method of claim 10 wherein the stream of numbers is stored in a terminal speed dialing memory location.

18. A telecommunications terminal comprising a microprocessor programmed to:
accept spoken words or DTMF tones originating from a third party into a the terminal;
recognizing the spoken words or DTMF tones as a telephone number;
convert the spoken words or DTMF tones into a stream of numbers representing a dialable telephone number; and
storing the stream of numbers in terminal memory for future recall and use for dialing the number provided by the party.

19. The terminal of claim 18 further comprising a DTMF tone interpretation module.

20. The terminal of claim 18 further comprising a speech to text module.
